(19) United States
(12) Patent Application Publication
(10) Pub. No.: US 2006/0051282 A1
(43) Pub. Date: Mar. 9, 2006

(54) Synthesis of carbon nanostructures

(75) Inventors: Zikang Tang, Hong Kong (CN); Ping Sheng, Hong Kong (CN); Qi Liang, Hong Kong (CN); Ning Wang, Hong Kong (CN); Che Ting Chan, Hong Kong (CN); Jian Ying Miao, Hong Kong (CN); Jianpang Zhal, Hong Kong (CN)

Correspondence Address: HESLIN ROTHENBERG FARLEY & MESITI PC, 5 COLUMBIA CIRCLE, ALBANY, NY, 12203, US

(73) Assignee: The Hong Kong University of Science and Technology, Hong Kong (CN)

(21) Appl. No.: 10/933,779

(22) Filed: Sep. 3, 2004

(51) Int. Cl. C01B 31/02

(52) U.S. Cl. 423/445 R

(57) ABSTRACT

A method for forming carbon nanostructures is disclosed. The method includes the steps of: (a) synthesising a microporous template material comprising crystals having no dimension greater than about 2 μm, (b) heating the crystals in the presence of an inert gas or a mixture of an inert gas and a carbon-containing gas at a temperature of between 500° C. and 900° C., and (c) recovering carbon nanostructures by washing the heated crystals in an acid to remove the template material.

### CROSS-REFERENCE TO RELATED APPLICATIONS

This Application is related to the following U.S. patent application:
U.S. patent application Ser. No. ______ entitled “LITHIUM-ION BATTERY INCORPORATING CARBON NANOSTRUCTURE MATERIALS” being filed concurrently herewith under Atty Dkt. No. 2055.017, which is hereby incorporated by reference herein in its entirety.

### FIELD OF THE INVENTION

This invention relates to novel methods for the synthesis of carbon nanostructures, in particular amorphous carbon nanostructures or very short single-walled nanotubes, and in particular to synthesis methods capable of producing carbon nanostructures reproducibly and on a large-scale.

### BACKGROUND OF THE INVENTION

Carbon is a multipurpose material which is widely used in many fields. There exist several different allotropes of carbon, and every allotrope shows very different properties. Carbon nanotubes, a new allotrope of carbon element (discovered by Iijama, Nature, Vol. 354, (1991), 56-58), have attracted a great deal of attention because of their novel properties as well as their potential applications in many fields. Carbon nanotubes are usually produced by several well-developed techniques, such as arc-discharge, laser ablation, chemical vapor deposition, etc. Recently, an alternative technique of aligned multi-walled nanotubes (MWNTs) using anodic aluminum oxide (AAO) films as templates are reported. (See, for example, Kyotani et al. Chemistry of Materials, Vol. 7, (1995), 1427-1428; Kyotani et al. Chemistry Community, (1997), 701-702).

Also known is a template technique involving the use of zeolite AFI as a template for growth of ultra-small single-walled carbon nanotubes (SWNTs) (Tang, et al., Appl. Phys. Lett., Vol. 73, (1998), 3270; Nature, Vol. 408, (2000), 50-51). High density, well aligned, uniform sized SWNT-arrays were produced by pyrolysis of tripropylamine molecules in the channels of the AFI crystals. It has been observed directly by transmission electron microscopy that these nanotubes have a diameter of as small as 0.4 nm with single layer graphitic wall, probably at or close to the theoretical limit. Such fine SWNTs even show superconductive properties at temperature below 15 K (Science, Vol. 292, (2001), 2462-2465).

The discovery of carbon nanotubes has driven the development and application of nano-structured carbon materials. It has been found, for example, nano-structured carbon materials produced using the template technique of Tang et al have a very high electrochemical performance of lithium intercalation. They are good negative materials for lithium-ion battery application. The practical use of carbon nanotubes in this and other application still requires, however, a synthesis technique that is capable of fabricating carbon nanotubes (and indeed other carbon nanostructures) on a large scale using reliable reproducible synthesis techniques.

### SUMMARY OF THE INVENTION

An object of the present invention therefore is to provide a convenient method or process for synthesizing nano-structured carbon on a large scale using relatively mild operating conditions. A further object of the present invention is to provide a method or process to synthesize nano-structured carbon using micro-porous materials as templates, wherein these nano-structured carbons are formed inside nano-pores (such as channels or cages) of the micro-porous materials with the resulting nano-structured carbons having mono-dispersed size and nano-scaled dimensions.

According to the present invention therefore there is provided a method for forming carbon nanostructures, comprising the steps of: (a) synthesising a microporous template material comprising crystals having no dimension greater than about 2 μm, (b) heating said crystals in the presence of an inert gas or a mixture of an inert gas and a carbon-containing gas at a temperature of between 500° C. and 900° C., and (c) recovering carbon nanostructures by washing the heated crystals in an acid to remove the template material.

In order to obtain the small-sized template crystals the template synthesis process may be modified by using a water/alcohol mixture as a solvent.

Preferably a carbon containing precursor is introduced into the template material during the synthesis of the template material. Possible carbon containing precursors include tetrapropylammonium, tetraethylammonium, choline, 2-picoline, 3-picoline, 4-picoline, triethylamine, tripropylamine, N,N-dimethylbenzylamine, piperidine, N-methylpiperidine, 3-methylpiperidine, cyclohexylamine, N-methylcyclohexylamine, 3-methylpiperidine, cyclohexylamine, N-methylcyclohexylamine, dicyclohexylamine, triethanolamine, N,N-diethylethanolamine, N,N′-dimethylpiperazine, 1,4-diazabicyclo-(2,2,2)octane, N,N-dimethylethanolamine, N-methyldiethanolamine, and N-methylethanolamine. If no carbon precursor is used during the synthesis of the template material, then a carbon-containing gas should be used during the heating step (b). Preferably both a carbon precursor and a carbon-containing gas may be used. Possible carbon-containing gases include methane, ethane, propane, butane, ethylene, propylene, acetylene, cyclohexane, carbon monoxide, or mixtures thereof.

A preferred template material comprises microporous aluminophosphate AlPO₄-5 crystals (AFI). Alternatives however include Faujasite, LTA, SBA-15 or 13X.

Preferably an element such as Si, Co, Ti, or Cr may be incorporated into the lattice structure of the template material during synthesis of the template material. This has been found to increase the yield of the carbon nanostructures.

### BRIEF DESCRIPTION OF THE DRAWINGS

Some embodiments of the invention will now be described by way of example and with reference to the accompanying drawings, in which:—

FIG. 1 shows a typical scanning electron microscope image of zeolite AFI crystals;

FIG. 2 shows a schematic diagram of a thermal chemical vapor deposition reactor for producing the nano-structured carbon in accordance with an embodiment of the invention;

FIG. 3 shows the formation of carbon nanostructures inside the channels of zeolite AFI crystal;

FIG. 4 shows a scanning electron microscope image of carbon nanostructures contained within AFI crystals;

FIG. 5(a) shows typical high-resolution transmission electron microscope image of carbon nanostructures obtained using AFI zeolite according to an embodiment of the invention;

FIG. 5(b) shows typical high-resolution transmission electron microscope image of carbon nanostructures obtained using Si-AFI zeolite according to an embodiment of the invention;

FIGS. 6(a) and (b) show the template material both before and after calcination where the template material is AFI, Si-AFI, Co-AFI, Ti-AFI and Cr-AFI;

FIGS. 7(a) and (b) show the template material both before and after calcination where the template material is provided as a carbon precursor with (a) triethylammonium hydroxide, (b) triethanolamine, (c) tripropylamine, (d) tetrapropylammonium-hydroxide; and

FIG. 8 shows a scanning electron micrograph of nanostructures obtained from SBA-15 zeolite.

### DETAILED DESCRIPTION OF PREFERRED EMBODIMENTS

The present invention, at least in its preferred forms, provides a method or process for the volume fabrication of nano-structured carbons and provides a simple and convenient technique to obtain the mono-dispersed nano-structured carbons. A preferred embodiment of the present invention will be described with reference to the Figures, but it will be understood that the invention is not limited thereto and many variations are possible.

In general terms a synthesis process of an embodiment of the present invention can be divided into two segments, (I) synthesis of micro-porous template materials, and (II) synthesis of nano-structured carbon using the templates. Segment-(I) provides a framework and a template for growth of nano-structured carbons. The growth of nano-structured carbon is carried out in segment-(II).

A wide range of micro-porous template materials may be employed in preferred embodiments of the invention. To function as effective templates, however, the micro-porous materials should contain nano-sized pores (channels, cages, etc.). The framework of the micro-porous material may contain at least one of or all of the following elements: Al, P, Si, Co, Cr and O, etc.

A suitable template material is porous zeolite AlPO₄-5 (AFI). AFI is known in the prior art as a template material for the fabrication of carbon nanostructures, but an important aspect of the present invention is that the AFI crystals are smaller than in the prior art, typically about 2 μm×2 μm×0.5 μm, or to express this idea in another way, with no dimension being greater than about 2 μm. The effect of using such smaller AFI crystals (compared with typical dimensions of about 500 μm×500 μm×100 μm in the prior art) is that the resulting nanostructures are formed with similar dimensions, i.e., with no dimension greater than about 2 μm. Smaller-sized AFI crystals can be produced, for example, using conventional AFI synthesis techniques but instead of using just water as the solvent, a water alcohol mixture may be used with an increasing alcohol content corresponding to a reduced AFI crystal size. The synthesis temperature may also be increased and the growth time extended (e.g., to three days).

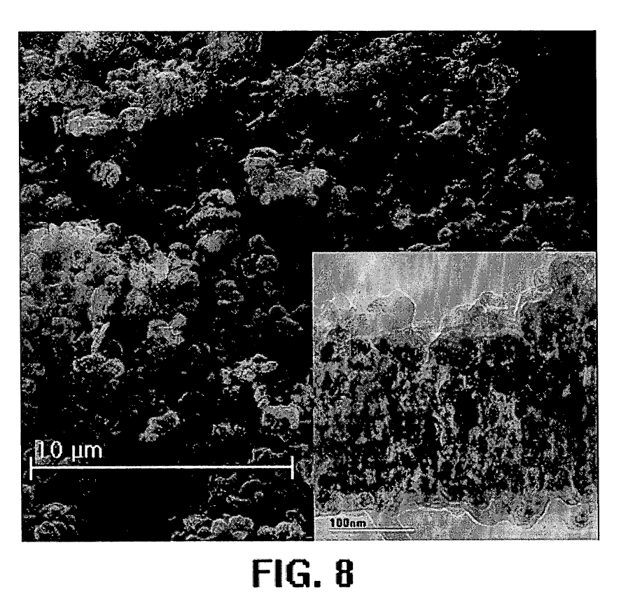

An element such as Si can also be introduced into the AFI crystals by adding a Si containing solution during the crystal growth process. Si-AFI is a particularly good form of zeolite for growing carbon nanostructures and takes the form SiₓAlP₍₁₋ₓ₎O₄-5 where 1<x<15% (0.01<x<0.15). A suitable solution for the synthesis of small-sized Si-AFI crystals is x(SiO₂):(iso-propanol)₃Al:1−x(H₃PO₄). While AFI is a particularly preferred form of template material, other microporous materials with similar pore sizes could also be used, such as for example Faujasite, LTA, SBA-15 or 13X. FIG. 8 for example shows an electron micrograph of nanostructured carbon materials obtained using a SBA-15 template material and it can be seen that these nanostructures have typical dimensions of about 20 nm.

Following, or during, fabrication of the micro-porous material carbon atoms may be introduced into the nano-sized pores of the template material. This may be achieved, for example, by adding a carbon containing chemical during the fabrication of the template material. Alternatively carbon may be introduced into the pores of the template material by subjecting the template material after formation to a carbon containing gas. Possible carbon containing precursor materials include: tetrapropylammonium, tetraethylammonium, choline, 2-picoline, 3-picoline, 4-picoline, triethylamine, tripropylamine, N,N-dimethylbenzylamine, piperidine, N-methylpiperidine, 3-methylpiperidine, cyclohexylamine, N-methylcyclohexylamine, 3-methylpiperidine, cyclohexylamine, N-methylcyclohexylamine, dicyclohexylamine, triethanolamine, N,N-diethylethanolamine, N,N′-dimethylpiperazine, 1,4-diazabicyclo-(2,2,2)octane, N,N-dimethylethanolamine, N-methyldiethanolamine, N-methylethanolamine, etc.

After formation of the template material, which may or may not at this stage include a carbon containing material in the nano-pores of the template material, the template material is placed in a thermal reactor. The reactor is capable of heating the template material to a temperature of between 400° to 900° C. The thermal reactor includes a chamber that can be maintained at vacuum or at a desired pressure, and further includes means for enabling a process gas to flow into the chamber. The template material is then subject to a preheating process in the presence of an inert gas at a flow rate of 100-500 ml/min. Following the preheating step, a second heating step is carried out during which a process gas may be introduced into the chamber. If the template material has been provided with the carbon precursor during formation of the template material, the process gas may be an inert gas only or a mixture of an inert gas and a carbon containing gas. If the template material has not been provided with a carbon precursor during formation of the template material, then the process gas must include a carbon containing gas in a concentration of between 20% and 100%. Possible hydrocarbon gases include methane, ethane, propane, butane, ethylene, propylene, acetylene, cyclohexane, carbon monoxide, or mixtures thereof.

The template material is then subjected to a heating step while being subjected to a flow of process gas. The heating step is carried out at a temperature of from 500° to 900° C., while the flow of the process gas is up to 500 ml/min. The heating step may be carried out for a period of from 2 to 20 hours. If an element such as Si has been introduced into the template material (eg Si-AFI) the temperature of this heating step can be reduced, e.g., from a typical temperature of about 600° C. to about 500° C. After the heating of the template material, the material is allowed to cool down naturally and the resulting samples are collected and subject to a mechanical grinding and sieving process to produce particles in the size range of 5 to 50 microns of the template material containing carbon nanostructures. An acid washing or etching technique is then used to remove the template material by dissolving the template material in acid (such as HCl, HNO₃. HF, H₂SO₄ or a mixture thereof) and the carbon nanostructures are recovered and dried in vacuum or in an inert gas. The carbon nanostructures may then be subjected to a subsequent post-treatment at high temperature in a flowing inert gas. As an alternative to dissolving in acid, the template material may be dissolved using a reflux process with continuous stirring.

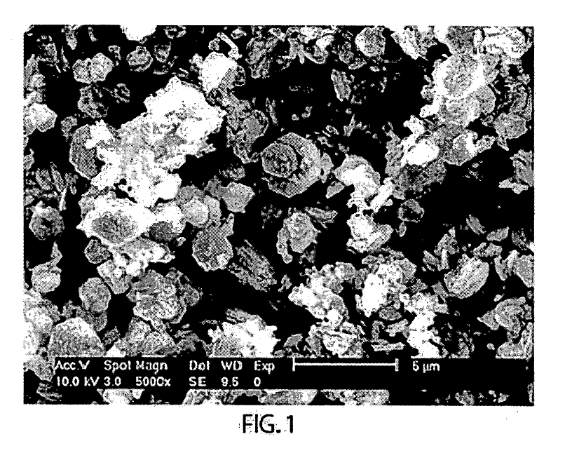

The synthesis of isolated single walled carbon nanotubes in the channels of AFI zeolite is described as follows. FIG. 1 shows a typical SEM (Philips XL30 Scanning Electron Microscope) image of the as-synthesized AFI porous crystals synthesized as described above a hydrothermal method in which the solvent is a water/alcohol mixture. The porous hexagonal crystals are about 2 μm×2 μm×0.5 μm in dimensions. The small-sized AFI crystals are formed including one or more carbon precursor material such as: tetraethylammonium, tetrapropylammonium, tetraethylammonium hydroxide, tetrapropylammonoium hydroxide, choline, 2-picoline, 4-picoline, triethylamine, N,N-dimethylbenzylamine, piperidine, N-methylpiperidine, 3-methlypiperidine, cyclohexylamine, N-methlycyclohexylamine, dicyclohexylamine, triethanolamine, N,N-diethylethanolamine, N-methyldiethanolamine and N-methylethanolamine.

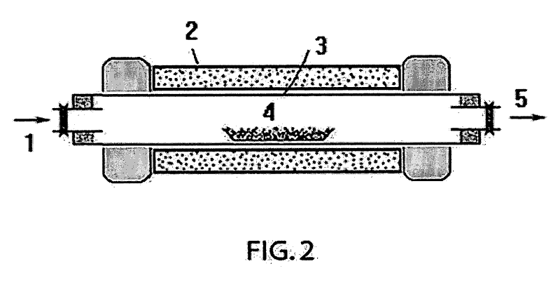

FIG. 2 shows a schematic illustration of apparatus for use in an embodiment of this invention. The apparatus is a fixed-bed reactor for synthesis of nano-carbon and is a tubular reactor comprising a valve inlet 1 for gases, a vacuum exhaust aperture 2, an electric furnace 3, a quartz tube 4 of about 50 cm diameter, a quartz vessel for holding a sample 5, and an outlet 6 for exhaust gases. The apparatus also comprises accessories such as a mass flow controller with at least three channels and a vacuum pump for generating a desired pressure within the reactor chamber.

The AFI-zeolite sample was loaded in the quartz vessel and was pre-heated to a pre-set temperature of about 600° C. (which is typically carried out at a low rate of about 1° C. per minute up to about 250° C., and then at a faster rate of about 5° C. per minute above that temperature), in a protective inert gas (about 400 ml/min). The inert gas flow will remove some decomposed products such as H₂O and NH₃.

After this pre-heating step the crystals are calcined. The pre-heating step and the calcinations are effectively a single continuous heating process with the calcinations starting at around 500° C. and reaching a steady-state of about 650° C. for 3 to 5 hours in situ. Even if no carbon precursor has been introduced into the AFI crystals, a carbon-containing gas is preferably mixed with the inert gas, and this is essential if no carbon precursor material has been included in the template. The flow rate of the carbon containing gas is controlled by a mass flow meter and is generally approximately 500 ml/min. The use of a carbon-containing gas in the calcinations process can increase the yield of carbon nanostructures by about 5%. After calcinations the products are cooled (under the presence of an inert gas only at 500 ml/min) to room temperature. The resulting nano-structured carbon/template composite is then collected and is ground by a mechanical grinding and sieving process into particles with size in a range of 5-50 microns. After dissolving the AFI framework in diluted HCl acid (e.g., 10 g nanocarbon/zeolite and 100 ml HCl is placed into a 250 ml flask and refluxed for 48 hours at 55° C.), the SWNT-containing solution is dispersed on a carbon film for HRTEM observation. The nanocarbons may be extracted using a polymer filter and washed with distilled water until a neutral pH value is obtained. Subsequently nanocarbons are dried in a vacuum oven and treated at high-temperature (e.g., 900° C.) and then cooled.

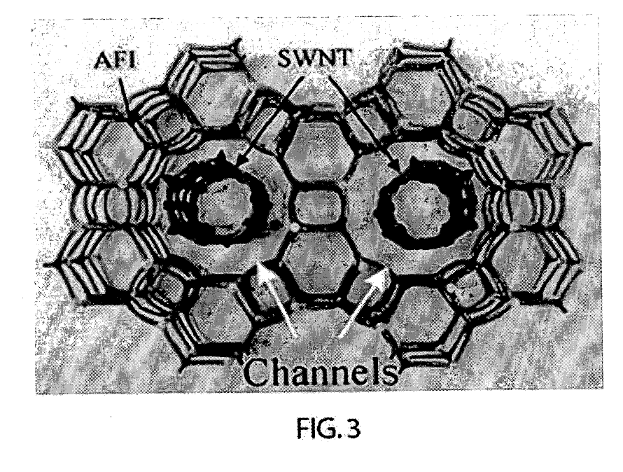

FIG. 3 shows a schematic of a SWNT/AFI complex, wherein SWNTs are formed inside the channels of the AFI-zeolite. The hexagonal packed one-dimensional channels have an inner diameter of 0.73 nm, and have a spacing of 1.37 nm between neighboring channels, marked by arrowheads.

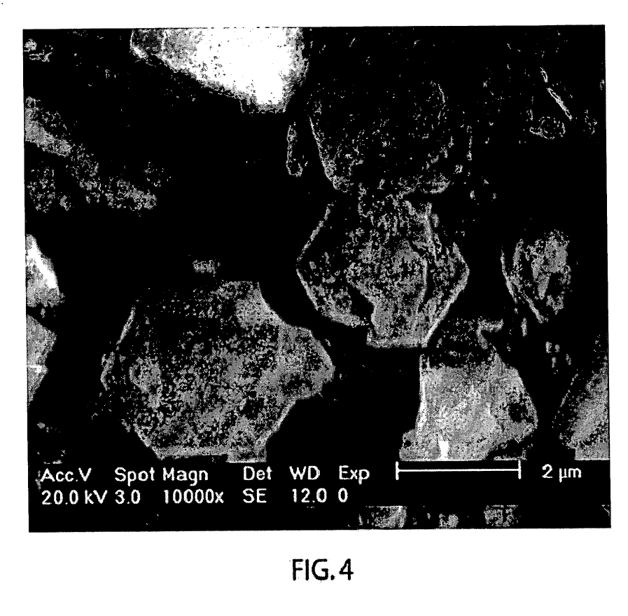

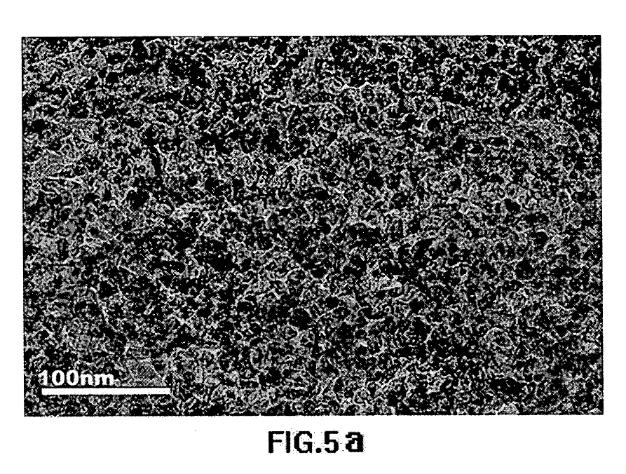

FIG. 4 shows a typical scanning electron microscope image of the SWNTs/AFI-zeolite composite materials. In the figure, the hexagonal AFI-zeolites containing SWNT-arrays inside their channels are coated by a thin layer of conductive carbon.

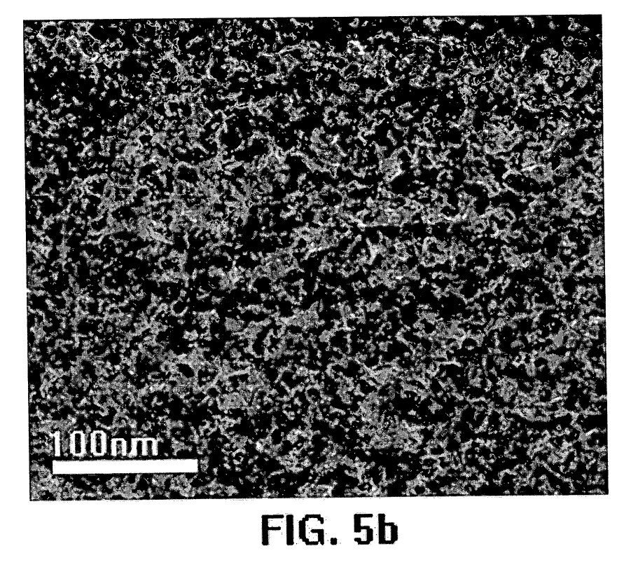

The post-treatment serves to remove the zeolite by means of an acid washing process. HCl, HNO₃, HF, and H₂SO₄ or mixtures thereof are particularly suitable for removing the zeolite, for example in a reflux process. The zeolites crystals are removed and the carbon nanostructures extracted. FIG. 5(a) shows a typical high-resolution transmission electron microscope (HRTEM) image of SWNTs released from AFI-zeolite (indicated by T and large arrowheads). From the HRTEM image, many SWNTs structures can be clearly seen. They have the same morphology with diameter of 0.42 nm.

As mentioned above the incorporation of another element (eg Si, Co, Ti and Cr) into the host zeolite, with the additional element replacing P in the AFI lattice, can increase the yield of carbon nanostructures and reduce the temperature at which the nanostructures are formed (eg from about 600° C. to about 500° C.). FIG. 5(b) shows carbon nanostructures formed using Si-AFI the template material and taking the form SiₓAlP₍₁₋ₓ₎O₄-5 where 1<x<15% (0.01<x<0.15). A suitable solution for the synthesis of small-sized Si-AFI crystals is x(SiO₂):(iso-propanol)₃Al:1−x(H₃PO₄). The incorporation of an element such as Si in the AFI crystal lattice can increase the yield of carbon nanostructures by up to 3 wt % to 5 wt % without using carbon containing gases, or 5 wt % to 8 wt % with the use of a carbon containing gas.

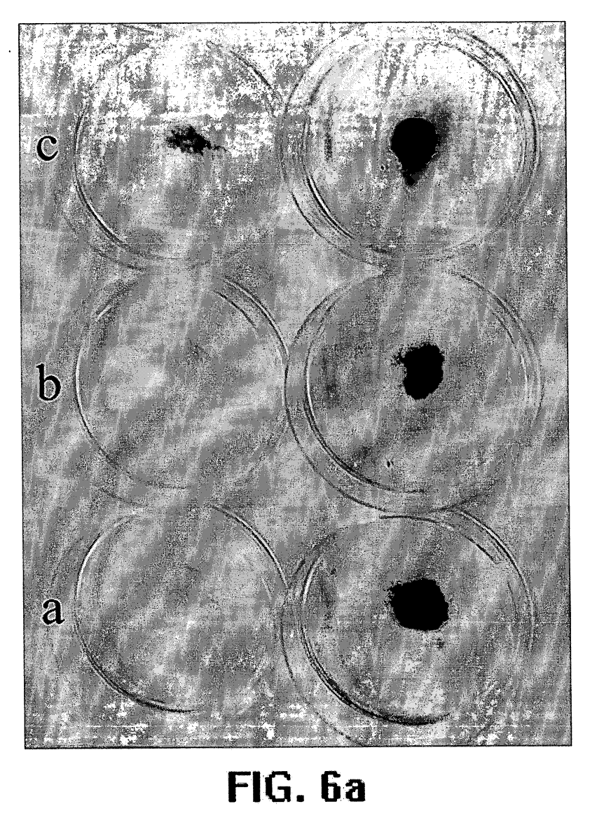

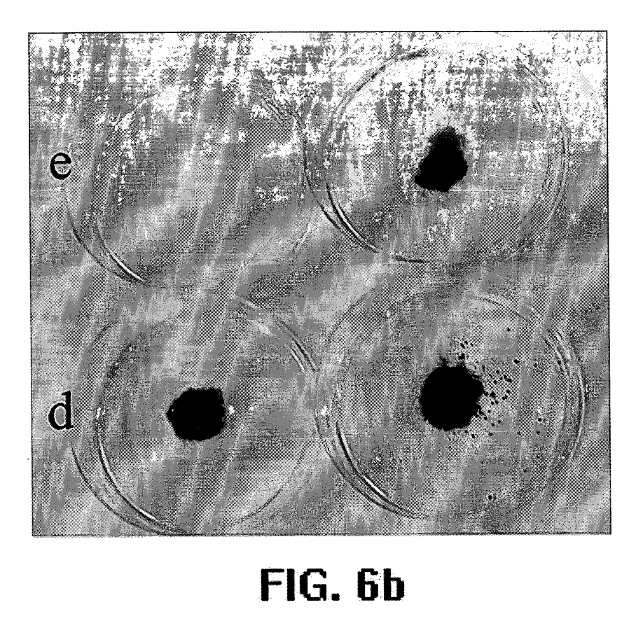

FIGS. 6(a) and (b) show on the left crystal template materials (a) AFI, (b) Ti-AFI, (c) Cr-AFI, (d) Co-AFI and (e) Si-AFI and on the right the same template materials but after calcinations. The change in colour on the right-hand side of FIGS. 6(a) and (b) shows the formation of the darker carbon nanostructures in the template crystals.

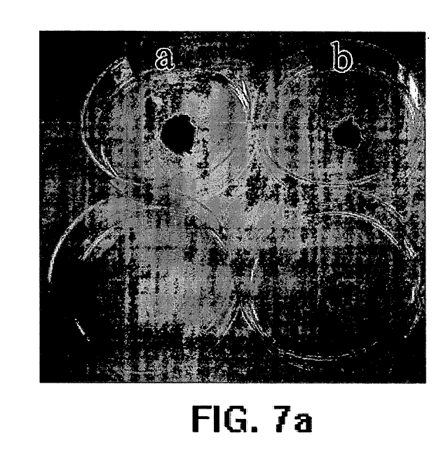

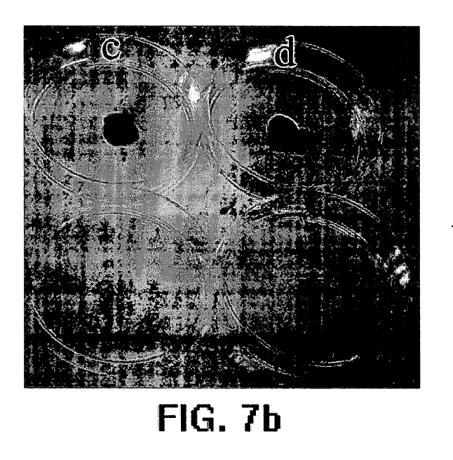

As described above it is preferable (though not essential if a carbon-containing gas is used in the calcinations stage) to introduce a carbon precursor in the template synthesis. FIGS. 7(a) and (b) show AFI templates before (below) and after (above) calcination for examples where the following carbon precursors are used in the template synthesis: (a) triethylammonium hydroxide, (b) triethanolamine, (c) tripropylamine, (d) tetrapropylammonium-hydroxide. The darker colours after calcinations show the formation of carbon nanostructures, and the increase in darkness from (a) to (d) suggests that tetrapropylammonium-hydroxide is the most effective at increasing the yield of carbon nanostructures.

The nanostructures formed are generally amorphous nanostructures, though at least some of the nanostructures may be considered to be very short length nanotubes.

It will thus be seen that the present invention, at least in its preferred forms, provides a method or process for synthesizing nano-structured carbons without introducing additional metal particles or islands as catalyst. The nano-structures may be one-, or two-, or three-dimensional structures with no dimensions being greater than 2 μm. The forms of nanostructures that can be produced by methods of the present invention include allotropes of carbon such as: nano-sized graphite, nanofibres, isolated carbon nanotubes, nano-balls, and amorphous carbon nano-particles.

A particular advantage of the present invention is that it provides a method or process for synthesizing the nano-structured carbon at a relatively mild temperature, usually between 400° C. and 900° C. The invention also provides a method or process that can readily be adapted to large-scale production and may be carried out using a production line with the minimal periodic interruption being required. The economy and efficiency of the production may therefore be significantly increased.

The following specific examples of the fabrication of nanocarbon structures using embodiments of the invention will now be provided:

### EXAMPLE 1

AFI (chemical component AlPO₄-5) was used as the zeolite template for fabrication of nanocarbons. Firstly AFI crystals were hydrothermally synthesized using triethanolamine (TEA) as organic templates. Thus, consequentially TEA was the inner carbon source for the formation of nanocarbons during the subsequent calcination step. The AFI zeolite crystals (crystal size 2 μm×2 μm×0.5 μm) were loaded into a quartz vessel and placed into a high-temperature tubular reaction chamber. In a pre-heating step, the heating rate was controlled at 1° C. per minute from room temperature to 250° C. with an inert gas flow over the chamber at 400 ml/min. From 250-700° C., the heating rate was increased to 8° C. per minute. At 700° C., the AFI crystals were calcined for 4 hours in argon 300 ml/min. When the temperature had cooled down to 25° C., black nanocarbons@zeolite complex were collected. The as-obtained nanocarbons@zeolite powder was dipped in HCl acid with reflux for 48 hours. After dissolving the AFI framework in HCl acid, filtering and washing with distilled water, nanocarbons were dried at nanocarbons@zeolite in a vacuum oven. The products were then annealed at 900° C. for 2 hours. In this process, the yield of nanostructured carbons was near to 3 wt % vs weight of zeolite. Nanocarbons dispersed on the carbon film were observed by HRTEM. In the HRTEM image FIG. 5a, the structure of nanocarbons was revealed clearly. They were uniform amorphous nano-particles with diameter of about 10 nm.

### EXAMPLE 2

In this example nanocarbons were synthesized with 3% Si-AFI zeolite as the template. The chemical component of the template was Si_{0.03}AlP_{0.97}O₄-5 with a feedstock recipe of 0.03(SiO₂):1(iso-Propanol)₃Al:0.97(H₃PO₄). Tripropylamine (TPA) employed as an organic templates during the hydrothermal synthesis of Si-AFI. The pre-heating and calcination steps were similar with that in Example 1. In the pre-heating step, the heating rate was controlled at 1° C. per minute from room temperature to 250° C. with an inert gas flow over the chamber at 400 ml/min. From 250-550° C., the heating rate was increased to 5° C. per minute. At 550° C., Si-AFI was calcined for 5 hours with a mixed gas of argon 200 ml/min and methane 300 ml/min. The as-obtained nanocarbons@zeolite was post-treated with HCl-washing 48 h, vacuum drying at 140° C. and high-temperature treatment at 900° C.

In this example TPA was the carbon precursor material and methane was used as the carbon-containing gas in the calcinations step. In this process, the yield of nanostructured carbons was about 6.5 wt % vs weight of zeolite. Nanocarbons were observed by HRTEM, they are more than 92% amorphous nano-particles (about 10 nm) and less than 8% nanotubes.

We claim:

1. A method for forming carbon nanostructures, comprising the steps of: (a) synthesising a microporous template material comprising crystals having no dimension greater than about 2 μm, (b) heating said crystals in the presence of an inert gas or a mixture of an inert gas and a carbon-containing gas at a temperature of between 500° C. and 900° C., and (c) recovering carbon nanostructures by washing the heated crystals in an acid to remove the template material.

2. A method as claimed in claim 1 wherein the synthesis of the template material is carried out using a water/alcohol mixture as a solvent.

3. A method as claimed in claim 1 wherein a carbon containing precursor is introduced into the template material during the synthesis of the template material.

4. A method as claimed in claim 3 wherein the carbon containing precursor is selected from the group consisting of: tetrapropylammonium, tetraethylammonium, choline, 2-picoline, 3-picoline, 4-picoline, triethylamine, tripropylamine, N,N-dimethylbenzylamine, piperidine, N-methylpiperidine, 3-methylpiperidine, cyclohexylamine, N-methylcyclohexylamine, 3-methylpiperidine, cyclohexylamine, N-methylcyclohexylamine, dicyclohexylamine, triethanolamine, N,N-diethylethanolamine, N,N′-dimethylpiperazine, 1,4-diazabicyclo-(2,2,2)octane, N,N-dimethylethanolamine, N-methyldiethanolamine, and N-methylethanolamine.

5. A method as claimed in claim 1 wherein atoms of Si, Co, Ti, or Cr are incorporated into the lattice structure of the template material during synthesis of the template material.

6. A method as claimed in claim 1 wherein the flow-rate of the inert gas or inert gas plus carbon containing gas is between 100 ml/min to 500 ml/min.

7. A method as claimed in claim 1 wherein a carbon-containing gas is present in step (b) and said carbon containing gas is selected from the group consisting of: methane, ethane, propane, butane, ethylene, propylene, acetylene, cyclohexane, carbon monoxide, or mixtures thereof.

8. A method as claimed in claim 1 wherein prior to step (b) the crystals are preheated from room temperature to the temperature of step (b) under the protection of an inert gas.

9. A method as claimed in claim 1 wherein the acid washing is performed using HCl, HNO₃, HF, H₂SO₄.

10. A method as claimed in claim 9 wherein the acid washing is performed using a reflux process.

11. A method as claimed in claim 1 wherein the template material comprises microporous aluminophosphate AlPO₄-5 crystals (AFI).

12. A method as claimed in claim 11 wherein the template material is selected from the group consisting of: Si-AFI, Co-AFI, Cr-AFI and Ti-AFI.

13. A method as claimed in claim 1 wherein the template material is Faujasite, LTA, SBA-15 or 13X.
